(19) United States
(12) Patent Application Publication
(10) Pub. No.: US 2015/0310012 A1
(43) Pub. Date: Oct. 29, 2015

(54) OBJECT-BASED IMAGE SEARCH SYSTEM AND SEARCH METHOD THEREOF

(71) Applicant: ODD CONCEPTS INC., Seoul (KR)

(72) Inventors: Jung-Tae KIM, Seoul (KR); Kyung-Mo KOO, Busan (KR)

(21) Appl. No.: 14/649,840

(22) PCT Filed: Dec. 11, 2013
(86) PCT No.: PCT/KR2013/011451

§ 371 Date: Jun. 4, 2015

(30) Foreign Application Priority Data
Dec. 12, 2012 (KR) 10-2012-0144059
Jan. 10, 2013 (KR) 10-2013-0002728

(51) Int. Cl. G06F 17/30

(52) U.S. Cl. CPC G06F 17/30047; G06F 17/30607; G06F 17/30598; G06F 17/30312; G06F 17/3025; G06F 17/30259; G06F 17/30256; G06F 17/30787; G06F 17/30864

(57) ABSTRACT

An object-based image search system effectively searches for a registered image or video having a configuration of object-based information similar to that of information input by a user or information related to the registered image or video. The searching system for object-based images is classifying or clustering registered images or videos according to feature points and attributes of the feature points in an object-based manner, and, if a user uploads an image or a video or searches for an image using a voice or text through a user terminal such as a PC, a tablet computer, a mobile terminal, a connected TV or the like, simply searching for matched images or videos from the registered images or the registered videos and providing the user terminal with a corresponding result or related information.

### BACKGROUND

The present invention relates to an object-based image search system and a search method thereof, which can effectively search for a registered image or video having a configuration of object-based information similar to that of information input by a user or information related to the registered image or video.

Generally, the Internet provides a lot of computer users with an effective and appropriate communication and information search means. Particularly, search methods for comparing and providing an image or a video corresponding to an image or a video uploaded by a user are continuously developed recently, and thus information search performed on a text or an image on the Internet has been progressed considerably.

However, there is a problem in that such search methods cannot reflect information on a plurality of objects in an image or a video queried by a user and, furthermore, cannot provide a result correctly reflecting an original intention of the user due to deficiency, misrecognition or the like of utilized information accompanied in the process of searching for similar images.

Furthermore, although a lot of information summation methods have been introduced to make a rapid search possible while minimizing loss of information in a large-capacity image or video DB, it is general that the search speed cannot but increase in proportion to the volume of DB, and in order to process further more pieces of image information within a memory use amount of a specific unit, loss of information proportional thereto comes together.

If a DB configured of images or videos is categorized by one-dimensional factors such as color, shape, texture, pattern and the like to overcome the problems, it is inconvenient to use, or accuracy of the search is severely diminished.

### SUMMARY OF THE INVENTION

Therefore, the present invention has been made in view of the above problems, and it is an object of the present invention to provide an object-based image search system and a search method thereof, which can reflect object information of each registered image or video in searching to handle composite information included in a variety of query means of a user.

Another object of the present invention to provide an object-based image search system and a search method thereof, which can process further more pieces of information on images and videos in a speedy way within a memory use amount of a specific unit while minimizing loss of information by clustering registered images or videos in an object-based manner.

Still another object of the present invention to provide an object-based image search system and a search method thereof, which can search for similar images or videos of a standard close to naked eyes or information related to these images by utilizing configuration information of objects, as well as recognizing identical objects, in a single search system.

To accomplish the above objects, according a first embodiment of the present invention, there is provided an object-based image search system including: a first registered-image management module (202) for storing and managing various kinds of registered images or videos, which will be a search target; a first registered-image information extraction module (203) for extracting feature points or visual attributes of the feature points from the registered images or videos as image information; a class creation module (209) for creating or classifying one or more classes according to similarity of the image information extracted through the first registered-image information extraction module (203); a first class information management module (210) for storing and managing information on the classes created through the class creation module (209); a first search contents information extraction module (211) for extracting information related to search contents for searching from an image, a video, a voice or a text received through a user terminal; a first registered-image search module (216) for searching for identically or similarly matched classes or registered images by comparing the search contents information extracted through the first search contents information extraction module (211) with class information; and a first search result display module (219) for providing the user terminal with the registered images searched by the first registered-image search module (216) or class information of the registered images as a search result, wherein the first search contents information extraction module (211) includes: a first search image processing unit (212) for extracting image information included in a search image received from a user; or a first search video processing unit (213) for analyzing a search video, partitioning sections of the video as scenes before and after a point where a visual element is converted, selecting one or more frames representing each scene as representative frames, and extracting image information from the selected representative frames.

Preferably, the feature point extracted by the first registered-image information extraction module (203) as image information is information created by a contour, a corner or a polar point (an area brighter or darker than brightness of surrounding areas) included in an image or a video, and the visual attribute of the feature point is brightness information, color information or pattern information that images around the feature point have.

Preferably, the first registered-image information extraction module (203) includes: a first registered-image image information extraction unit (204) for extracting feature points included in the registered images or visual attributes of the feature points as image information and storing the extracted image information; and a first registered-video image information extraction unit (205) including: a first scene partitioning unit (206) for analyzing a registered video and partitioning sections of the video as scenes before and after a point where a visual element is converted; a first representative frame selection unit (207) for selecting one or more frames representing each scene as representative frames; and a first representative frame image information extraction unit (208) for extracting feature points or visual attributes of the feature points from the selected representative frames as image information and storing the extracted image information.

Preferably, the first scene partitioning unit (206) creates frequency graphs of HAV (hue/saturation/value) from each frame of video contents, compare graphs of a previous frame and a current frame, and, if a distance between the graphs is larger than a predetermined distance value, determines that the frames are changed and confirm the frames as scenes.

Preferably, when the feature point or the visual attribute of the feature point, which is image information, is similar to image information in a registered image or a registered video, the class creation module (209) creates or classifies the image information as one or more classes by clustering the image information, and if the classes created at this point have image information similar to that of a previously created class, the class creation module (209) classifies the classes together as identical or similar classes.

Preferably, the class information of the first class information management module (210) is one or more of text information describing a class, image information, category information and specialized information.

Preferably, the first search contents information extraction module (211) includes: a first search voice processing unit (214) for analyzing a voice provided by the user terminal and converting the voice into text; and a first search text processing unit (215) for analyzing a search text provided by the user terminal or the text converted by the first search voice processing unit (214).

Preferably, the first registered-image search module (216) includes: a first image search unit (217) for searching for identically or similarly matched classes by comparing the image information extracted from a search image or a search video submitted by the user with image information of each class in the class information and searching for registered images or registered videos including some or all of the searched classes; and a first text search unit (218) for searching for identically or similarly matched classes by comparing text information extracted or converted from a text or a voice submitted by the user with text information in the class information and searching for registered images or registered videos including some or all of the searched classes.

In addition, according to a second embodiment of the present invention, there is provided an object-based image search system including: an object image management module (301) for registering and storing an object image including one or more objects, extracting image information from the registered object image, and storing the image information together with the object image; a second class information management module (302) for classifying the image information of the object image as one or more identical classes by clustering the image information extracted through the object image management module (301) according to similarity of the image information, and storing text of classes describing the corresponding classes together as class information; a second registered-image management module 303 for storing and managing various kinds of registered images or videos, which will be a search target, as registered images; a second registered-image information extraction module (304) for extracting feature points or visual attributes of the feature points from all or some of the registered images or videos as image information; a registered-image classification module (310) for comparing, if image information is extracted from the registered images or the registered videos, corresponding image information with image information of the previously created classes and storing information on classes having identical or similar image information together with the registered images or videos; a second search contents information extraction module (311) for extracting search contents information from search contents including an image, a video, a voice or a text received through a user terminal; a second registered-image search module (316) for searching for identically or similarly matched classes by comparing the search contents information extracted through the second search contents information extraction module 311 with image information of the previously created classes or text of the classes and searching for registered images or registered videos including all or some of the searched classes; and a second search result display module (319) for providing the user terminal with information on the classes or the registered images searched by the second registered-image search module (316) as a search result, wherein the second search contents information extraction module (311) includes one or more of a second search image processing unit (312) for extracting image information included in a search image received from a user; a second search video processing unit (313) for analyzing a search video, partitioning sections of the video as scenes before and after a point where a visual element is converted, selecting one or more frames representing each scene as representative frames, and extracting image information from the selected representative frames; a second search voice processing unit (314) for analyzing a voice provided by the user terminal and converting the voice into text; and a second search text processing unit (315) for analyzing a search text provided by the user terminal or the text converted by the second search voice processing unit (314).

### BRIEF DESCRIPTION OF THE DRAWINGS

FIG. 1 is a block diagram showing an object-based image search system according to a first embodiment of the present invention.

FIG. 2 is a flowchart illustrating an image contents search process using an object-based image search system according to a first embodiment of the present invention.

FIG. 3 is a flowchart illustrating an example of creating a class according to a first embodiment of the present invention.

FIG. 4 is a flowchart illustrating a search process using a voice or text performed by using an object-based image search system according to a first embodiment of the present invention.

FIG. 5 is a block diagram showing an object-based image search system according to a second embodiment of the present invention.

FIG. 6 is a flowchart illustrating an image contents search process using an object-based image search system according to a second embodiment of the present invention.

### DETAILED DESCRIPTION OF THE PREFERRED EMBODIMENT

The preferred embodiments of the invention will be hereafter described in detail, with reference to the accompanying drawings.

The basic concept of an image contents search system according to a first embodiment of the present invention is classifying or clustering registered images or videos according to feature points and attributes of the feature points in an object-based manner, and, if a user uploads an image or a video or searches for an image using a voice or text through a user terminal such as a PC, a tablet computer, a mobile terminal, a connected TV or the like, simply searching for matched images or videos from the registered images or the registered videos and providing the user terminal with a corresponding result or related information.

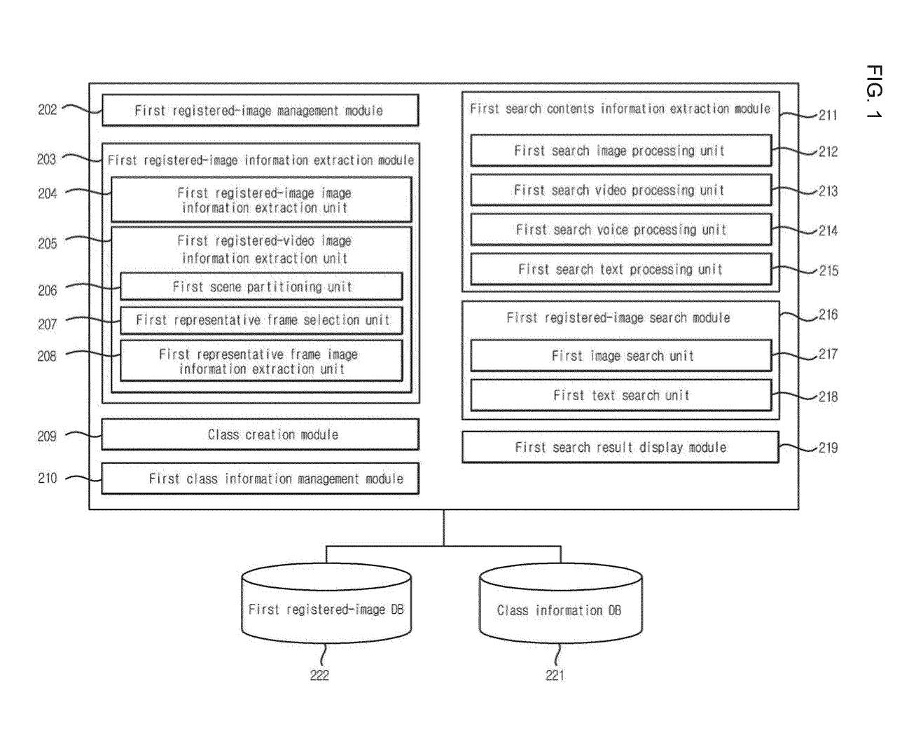

Describing the image contents search system in detail with reference to FIG. 1, the image contents search system includes a first registered-image management module 202, a first registered-image information extraction module 203, a class creation module 209, a first class information management module 210, a first search contents information extraction module 211, a first registered-image search module 216 and a first search result display module 219.

The first registered-image management module 202 stores and manages various kinds of registered images or videos, which will be a search target, in a first registered-image DB 221. At this point, the first registered-image management module 202 may store an image or a video, which will be a search target, as a registered image or a registered video or search for and use the image or the video in real-time through a web. In addition, when an image or a video is registered in the first registered-image management module 202, related information including a name of the registered image or video, a copyright holder and the like can be stored together.

The first registered-image information extraction module 203 extracts feature points or visual attributes of the feature points from the registered image or video as image information. The feature point extracted as image information is information created by a contour, a corner or a polar point (an area brighter or darker than the brightness of surrounding areas) included in the image or the video, and the visual attribute of the feature point means brightness information, color information, pattern information and the like that the images around the feature point have.

Such a first registered-image information extraction module 203 is configured of a first registered-image image information extraction unit 204 for extracting image information from a registered image, and a first registered-video image information extraction unit 205 for extracting image information from a registered video.

The first registered-image image information extraction unit 204 extracts one or more feature points included in the registered images or visual attributes of the feature points as image information and stores the extracted image information together with the registered images. All the image information included in each of the registered images can be extracted through the first registered-image image information extraction unit 204.

The first registered-video image information extraction unit 205 is configured of a first scene partitioning unit 206 for analyzing a registered video and partitioning sections of the video as scenes before and after a point where a visual element is converted, a first representative frame selection unit 207 for selecting one or more frames representing each scene as representative frames, and a first representative frame image information extraction unit 208 for extracting one or more feature points or visual attributes of the feature points from the selected representative frames as image information and storing the image information together with the registered videos. At this point, the first scene partitioning unit 206 may create frequency graphs of HAV (hue/saturation/value) from each frame of video contents, compare graphs of a previous frame and a current frame, and, if the distance between the graphs is larger than a predetermined distance value, determine that the frames are changed and confirm the frames as scenes, and it is preferable that a unique ID is assigned to each of the confirmed scenes. At this point, it is preferable to classify the frames by expressing a frame starting the change as S (Start) and a frame ending the change as E (End). In addition, since frames configuring a scene are almost similar to each other, any frame in the front, middle and rear parts may be selected as a representative frame by the first representative frame selection unit 207. The image information included in the registered video, as well as the image information of the registered image, can be extracted by the first registered-image information extraction module 203.

The class creation module 209 compares the image information of the feature points or the visual attributes of the feature points of the registered image or the registered video extracted by the first registered-image information extraction module 203 with each other, and creates the image information as one or more classes by clustering the image information together if the image information is identical or similar to each other, or classifies the image information as an existing class if the image information is identical to a previously created class. For example, a class may be classified into nature>>mountain, sea, sky, earth>>sky>>blue sky, evening sky or the like.

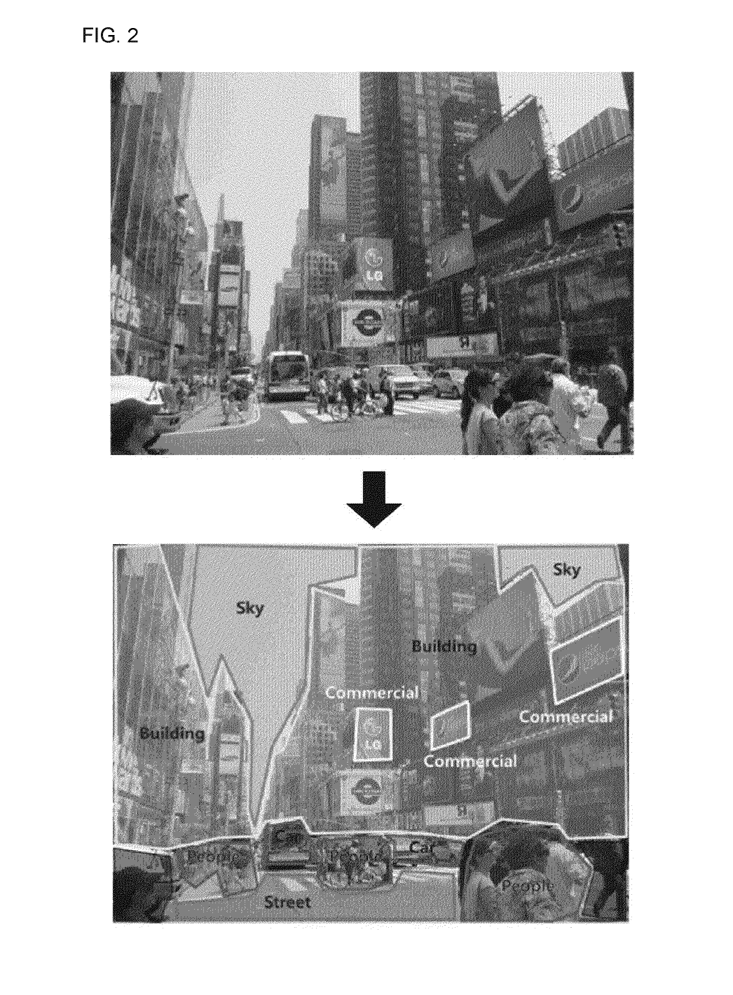

The first class information management module 210 stores and manages class information of the classes created through the class creation module 209 in a class information DB 222. At this point, the class information stored in the class information DB 222 is configured to include one or more of image information of each class, category information, text information related to description of the class and specialized information. The image information includes the feature points of each class or the visual attributes of the feature points created through the first class creation module 209, and the category information means class information classified by the hierarchical concept, dependency, correlation or the like among the classes. For example, in the case of category information according to the hierarchical concept, blue skies, a street having a crosswalk, high-rise buildings in downtown, LG, Pepsi, people, cars and the like can be classified as classes from the image information of an image as shown in FIG. 2. In addition, a class of a blue sky is classified as a category of nature>sky>blue sky by the hierarchical concept. In addition, category information according to the dependency includes information on other registered images or registered videos in the DB including a corresponding class and classes similar to the corresponding class for each class, and category information according to the correlation includes information on other classes in the DB similar to a corresponding class for each class. The text information includes keywords or text describing or representing each class, and such information may be provided by the first registered-image management module 202 storing a name of the registered image or video, information on a copyright holder and the like together, or provided by a manager.

The first search contents information extraction module 211 extracts information related to search contents for searching from an image, a video, a voice or a text received through a user terminal. The user terminal includes terminals such as a PC, a tablet computer, a mobile terminal, a connected TV and the like, and an image played back or photographed by the user terminal or an image file or an image stored in the user terminal is provided as a search image.

The first search contents information extraction module 211 is configured of a first search image processing unit 212, a first search video processing unit 213, a first search voice processing unit 214 and a first search text processing unit 215.

The first search image processing unit 212 extracts image information from a search image received from a user. Such image information extracted by the first search image processing unit 212 includes feature point information of a contour, a corner or a polar point (an area brighter or darker than the brightness of surrounding areas) of an object included in the search image and visual information such as brightness information, color information, pattern information and the like that the images around the feature point have, in a manner the same as the method of extracting image information by the first registered-image image information extraction unit 204. Image information included in the search image submitted by the user can be extracted through the first search image processing unit 212.

The first search video processing unit 213 analyzes a search video, partitions sections of the video as scenes before and after a point where a visual element is converted, selects a frame representing each scene as a representative frame, and extracts image information from the selected representative frame. The image information is extracted by the first search video processing unit 213 such that image information of a representative frame is extracted from the search video in a process the same as the process of the first scene partitioning unit 206, the first representative frame selection unit 207 and the first representative frame image information extraction unit 208 of the first registered-video image information extraction unit 205 described above. Accordingly, the image information included in the search video submitted by the user can be extracted through the first search video processing unit 213.

The first search voice processing unit 214 analyzes a voice provided by the user terminal and converts the voice into text. Such a first search voice processing unit 214 may convert a voice into text using a speech recognizer. For example, it converts a voice of “Search for an image of downtown crowded with people, cars and buildings, excluding images taken in the evening.” into text.

The first search text processing unit 215 analyzes a search text provided by the user terminal or the text converted by the first search voice processing unit 214.

The first registered-image search module 216 searches for one or more identically or similarly matched classes by comparing information on the search contents extracted through the first search contents information extraction module 211 with previously classified class information and searches for registered images or registered videos including all or some of corresponding classes. The first registered-image search module 216 is configured of a first image search unit 217 for searching for image information and a first text search unit 218 for comparing text.

The first image search unit 217 searches for identically or similarly matched classes by comparing image information extracted from a search image or a search video submitted by a user with image information of each class in the class or searches for registered images or registered videos including some or all of the searched classes. At this point, one or more classes corresponding to each image information can be primarily searched for from the image information of the search image or the search video, and, secondarily, registered images or registered videos including all or some of the one or more searched classes can be searched for.

The first text search unit 218 searches for identically or similarly matched classes by comparing text information extracted or converted from a text or a voice submitted by a user with text in the class information and searches for registered images or registered videos including some or all of the searched classes. At this point, the first text search unit 218 primarily searches for identical or similar classes and secondarily searches for registered images or registered videos including all or some of corresponding classes. For example, if the text information analyzed by the first text search unit 218 is “Search for an image of downtown crowded with people, cars and buildings, excluding images taken in the evening.”, matched classes are detected by comparing text information on people, cars and buildings with text stored as class information, and classes of a reddish color can be excluded by reflecting text information on color extracted from the image information of the classes. It is possible to search for registered images or registered videos including all or some of the classes identical or similar to the classes detected through the selection and control as described above.

The first search result display module 219 provides the user terminal with information on the classes or the registered images searched by the first registered-image search module 216 as a search result.

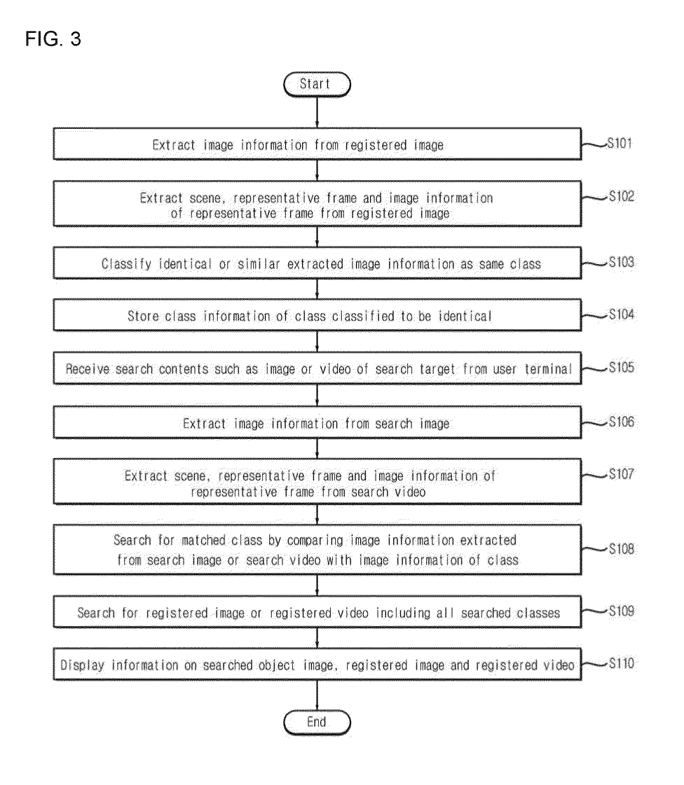

Hereinafter, a search process of an object-based image search system according to a first embodiment of the present invention is described in detail with reference to the flowchart of FIG. 3.

First, feature points of a registered image, which will be a search target, or visual attributes of the feature points are extracted as image information through the first registered-image information extraction module 203 (step S101), and feature points of each representative frame or visual attributes of the feature points are extracted from a registered video as image information (step S102). At this point, the feature point extracted as image information is information created by a contour, a corner or a polar point (an area brighter or darker than the brightness of surrounding areas) included in an image or a video, and the visual attribute of the feature point means brightness information, color information, pattern information and the like that the images around the feature point have. In addition, a registered video may be analyzed to partition sections of the registered video as scenes before and after a point where a visual element is converted, select a frame representing each scene as a representative frame, and extract feature points or visual attributes of the feature points from the selected representative frames as image information. Through the process as described above, image information on feature points or visual attributes of the feature points can be extracted from a registered image or a representative frame.

Meanwhile, the class creation module 209 creates or classifies the extracted image information as one or more classes by clustering the image information according to identity or similarity of the image information and interconnects or stores the registered image or video and each class information in the registered image or video together in a form easy to be called from each other (step S103). At this point, newly created classes having image information similar to that of a previously created class can be classified together as classes identical or similar to the previously created class.

Meanwhile, the first class information management module 210 stores class information of the classes created through the class creation module 209 in the class information DB 222 (step S104). The class information includes one or more of image information of each class, category information, text information and specialized information, and such information can be provided by the first registered-image management module 202 which stores a name of the registered image or video, information on a copyright holder and the like together, or provided as a result of the secondary search performed through a web using data provided by the first registered-image management module 202, or provided by the manager. Accordingly, although a plurality of classes is included in a registered image or a registered video, the classes included therein can be simply confirmed by storing the class information together.

Meanwhile, if search contents such as an image, a search video or the like desired to be searched for are received from the user terminal (step S105), the first search contents information extraction module 211 extracts image information of the search contents provided by the user.

That is, if a search image or a search video is provided by the user terminal, the first search image processing unit 212 of the first search contents information extraction module (211) extracts feature points or visual attributes of the feature points from the search image as image information (step S106), and the first search video processing unit 213 extracts feature points or visual attributes of the feature points included in the representative frame from the search video as image information (step S107). Through the process as described above, feature points or visual attributes of the feature points can be extracted from a search image or a search video as image information.

In addition, the first registered-image search module 216 searches for identical or similar classes by comparing image information such as the feature points extracted from the search image or the search video, the visual attributes of the feature points or the like with image information of the classes (step S108) and searches for registered images or registered videos including all or some of the searched classes (step S109).

Meanwhile, information on the searched classes or registered images is created as a list and provided to the user terminal through the first search result display module 219 as a search result (step S110).

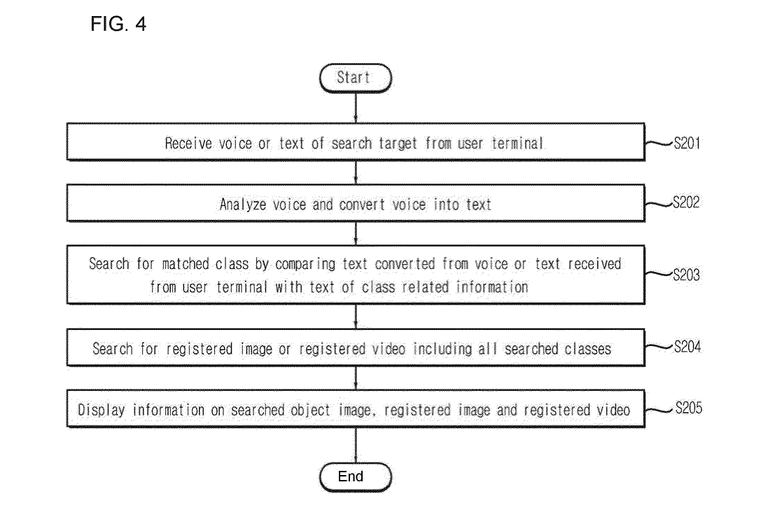

On the other hand, as shown in FIG. 4, if search contents such as a voice or text desired to be searched for are provided by the user terminal through a search contents reception module (step S202), the first search voice processing unit 214 of the first search contents information extraction module 211 converts the provided voice into text using a speech recognizer or the like (step S203).

In addition, the first text search unit 218 of the first registered-image search module 216 searches for classes having identically or similarly matched text by comparing the text converted from the voice or a search text directly provided as text from the user terminal with text of the class information (step S204) and searches for registered images or registered videos including all or some of the searched classes (step S205). Accordingly, related registered images or videos can be searched for from a voice or text describing an image or a video.

Meanwhile, information on the searched classes or registered images is created as a list and provided to the user terminal through the first search result display module 219 as a search result (step S206).

The basic concept of an image contents search system according to a second embodiment of the present invention is inputting an object image including one or more objects into the image contents search system, extracting image information from the object image, creating or classifying the extracted image information as one or more classes according to similarity or identity of the image information, matching image information of the created classes to image information of a registered image or video, which will be a search target, and, if a user requests search for an image by means of search contents including an image, a video, a voice or a text, extracting search contents information from the search contents, searching for class information matched to the search contents information, and searching for registered images or registered videos sharing one or more classes similar or identical to a searched result.

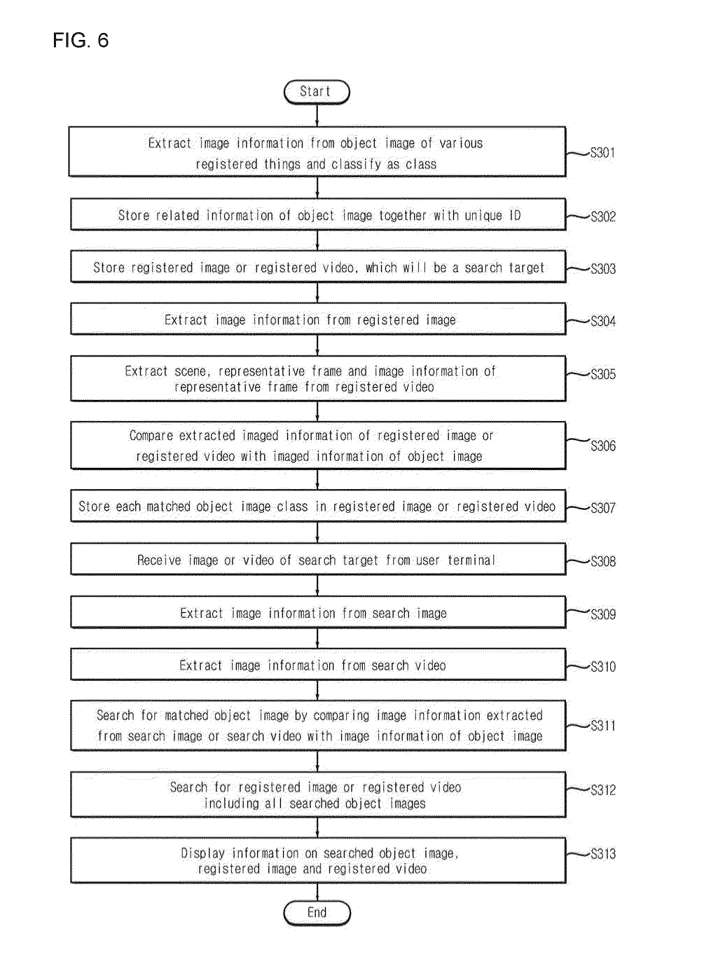

Describing the image contents search system according to a second embodiment of the present invention in detail with reference to FIG. 6, the image contents search system includes an object image management module 301, a second class information management module 302, a second registered-image management module 303, a second registered-image information extraction module 304, a second search contents information extraction module 311, a second registered-image search module 316 and a second search result display module 319.

The object image management module 301 is registered with an object image including one or more of a variety of objects such as a sky, a person, a building, a street and the like, stores the object image in an object image DB 320, extracts image information from the registered object image, creates or classifies the image information as one or more classes by clustering the image information according to identity or similarity of the image information, and stores the classes in the object image DB 320 together with the image information. At this point, the image information of the object image can be extracted according to feature point information of a contour, a corner or a polar point (an area brighter or darker than the brightness of surrounding areas) of an object included in the image and visual attributes of the feature points (brightness information, color information, pattern information and the like that the images around the feature point have). The extracted image information of the object image is created or classified as one or more classes by clustering the image information according to similarity of the image information, and newly created classes having image information similar to that of a previously created class can be classified together as identical or similar classes.

The second class information management module 302 stores information on the classes created through the object image management module 301 in the object image DB 320 together with the image information. At this point, a unique ID may be assigned to each of the classes, and the class information includes one or more of image information of each class, category information, text information and specialized information.

The second registered-image management module 303 stores and manages various kinds of registered images or videos, which will be a search target, in a second registered-image DB 321, in the same manner as the first registered-image management module 202. When an image or a video is registered in the second registered-image management module 303, related information including a name of the registered image or video, a copyright holder and the like can be stored together.

The second registered-image information extraction module 304 extracts feature points of the registered image or video or visual attributes of the feature points as image information, in the same manner as the first registered-image information extraction module 203. The second registered-image information extraction module 304 is configured of a second registered-image image information extraction unit 305 for extracting image information from the registered images, and a second registered-video image information extraction unit 306 for extracting image information from the registered videos, and, in addition, the second registered-video image information extraction unit 306 is configured of a second scene partitioning unit 307, a second representative frame selection unit 308 and a second representative frame image information extraction unit 309. Since the second registered-image image information extraction unit 305 and the second registered-video image information extraction unit 306 are the same as the first registered-image image information extraction unit 204 and the first registered-video image information extraction unit 205, description thereof will be omitted.

If image information is extracted from each of the registered image and the registered video through the second registered-image information extraction module 304, a registered-image classification module 310 compares the extracted image information with image information of each class stored in the object image DB 320 and stores information on classes having identical or similar image information. At this point, the registered-image classification module 310 may store and record ID information of the classes matched to the registered image.

The second search contents information extraction module 311 extracts information on search contents for searching from an image, a video, a voice or a text received through a user terminal, in the same manner as the first search contents information extraction module 211 of a first embodiment. The second search contents information extraction module 311 is configured of a second search image processing unit 312, a second search video processing unit 313, a second search voice processing unit 314 and a second search text processing unit 315, in the same manner as the first search contents information extraction module 211.

The second registered-image search module 316 searches for one or more identically or similarly matched classes by comparing image information of the search contents extracted through the second search contents information extraction module 311 with image information of the classes stored in the object image DB 320 and searches for registered images or registered videos including all or some of corresponding classes. The second registered-image search module 316 is configured of a second image search unit 317 for searching for image information and a second text search unit 318 for comparing text.

The second image search unit 317 searches for identically or similarly matched classes by comparing image information extracted from a search image or a search video submitted by a user with image information of the classes and searches for registered images or registered videos including some or all of the searched classes. At this point, one or more classes corresponding to the image information of the search image or the search video can be primarily searched for, and, secondarily, registered images or registered videos including all or some of the corresponding classes can be searched for.

The second text search unit 318 searches for identically or similarly matched classes by comparing text information extracted or converted from a text or a voice submitted by a user with text in the class information and searches for registered images or registered videos including some or all of the searched classes. At this point, the second text search unit 318 primarily searches for identical or similar classes and secondarily searches for registered images or registered videos.

The second search result display module 319 provides the user terminal with information on the classes or the registered images searched by the second registered-image search module 316 as a search result.

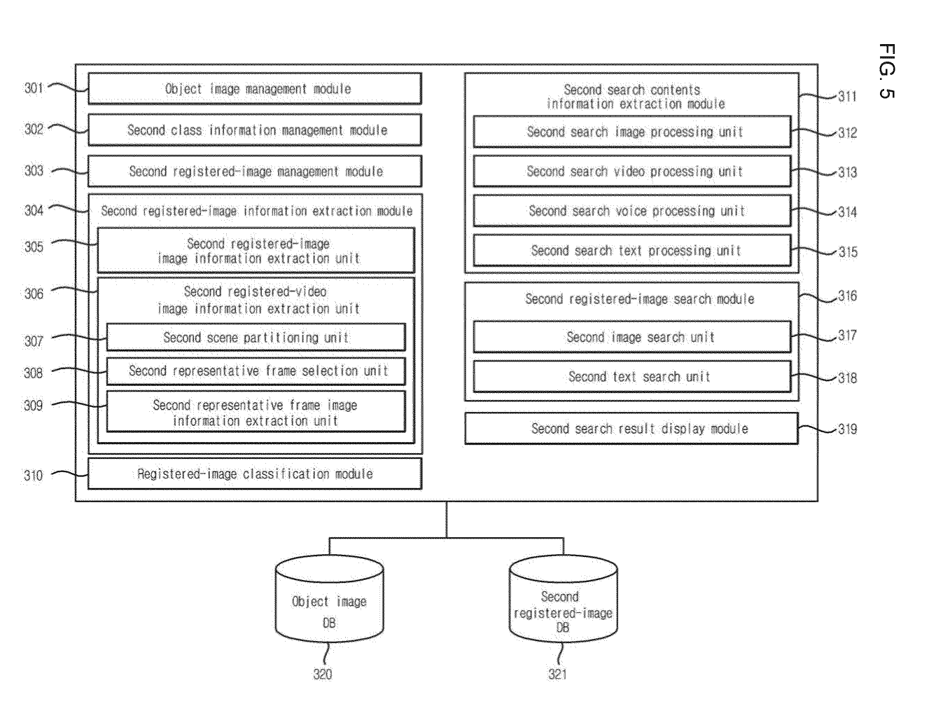

Hereinafter, an image contents search process according to the present invention is described in detail with reference to the flowchart of FIG. 5.

First, the object image management module 301 is registered with an object image including one or more of a variety of objects such as a sky, a building, a person, a street and the like, stores the object image in an object image DB 320, extracts image information of the registered object image, and creates or classifies the image information as one or more classes by clustering the image information according to identity or similarity of the image information (step S301). At this point, the image information of the object image can be created or classified as classes by clustering the image information according to similarity of feature point information of a contour, a corner or a polar point (an area brighter or darker than the brightness of surrounding areas) of an object included in the image and visual attributes of the feature points.

In addition, the second class information management module 302 stores image information of the classes and information related to the classes together in the object image DB 320. At this point, a unique ID may be assigned to each class, and the information related to the classes is configured of one or more of text information describing the class, category information and specialized information.

Meanwhile, a registered image or a registered video, which will be a search target, is registered and stored through the second registered-image management module 303 (step S303), and the registered image or the registered video registered is used to extract image information from the registered image (step S304) and extract image information of each representative frame from the registered video (step S305) through the second registered-image information extraction module 304.

Then, through the second registered-image management module 303, identically or similarly matched classes are confirmed by comparing the extracted image information of the registered image or video with image information in the class (step S306), and information on the matched classes is stored in the registered image together (step S307). Accordingly, although a plurality of objects is included in a registered image or a registered video, the objects included therein can be simply confirmed if an ID of a matched class is stored together.

Meanwhile, if search contents of an image or a video desired to be searched for are provided by the user terminal (step S308), the second search contents information extraction module 311 extracts image information of the search contents provided by the user for searching.

That is, feature points or visual attributes of the feature points are extracted from a search image provided by the user terminal as image information (step S309), or feature points included in a representative frame or visual attributes of the feature points are extracted from a search video as image information (step S310). Through the process described above, image information can be extracted from a search video, as well as a search image.

Then, the second registered-image search module 316 searches for matched classes by comparing the image information extracted from the search image or the search video input through the user terminal with image information of the classes (step S311) and searches for registered images or registered videos including all or some of the searched classes (step S312).

Information on the searched classes or registered images is created as a list and provided to the user terminal through the second search result display module 319 as a search result (step S313).

Meanwhile, since the process of searching for an image using an object-based image search system according to a second embodiment when the search contents are a voice or a text is the same as that of embodiment 1, description thereof will be omitted.

The object-based image search system according to the present invention is advantageous in that it is possible to effectively handle composite information input through a variety of query means by using a plurality of pieces of object-based information extracted from an image or a video.

In addition, further more pieces of information on images and videos can be processed in a speedy way within a memory use amount of a specific unit while minimizing loss of information by clustering registered images or videos in an object-based manner.

In addition, since similar images or videos of a standard close to naked eyes or information related to these images can be searched for in a single search system by utilizing configuration information of objects, as well as recognizing identical objects, a three-dimensional search method meeting an intention of a user can be provided.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. An object-based image search system comprising:
a first registered-image management module (202) for storing and managing various kinds of registered images or videos, which will be a search target;
a first registered-image information extraction module (203) for extracting feature points or visual attributes of the feature points from the registered images or videos as image information;
a class creation module (209) for creating or classifying one or more classes according to similarity of the image information extracted through the first registered-image information extraction module (203);
a first class information management module (210) for storing and managing information on the classes created through the class creation module (209);
a first search contents information extraction module (211) for extracting search contents information for searching from an image, a video, a voice or a text received through a user terminal;
a first registered-image search module (216) for searching for identically or similarly matched classes or registered images by comparing the search contents information extracted through the first search contents information extraction module (211) with class information; and
a first search result display module (219) for providing the user terminal with information on the classes or information on the registered images searched by the first registered-image search module (216) as a search result, wherein
the first search contents information extraction module (211) includes:
a first search image processing unit (212) for extracting image information included in a search image received from a user; or
a first search video processing unit (213) for analyzing a search video, partitioning sections of the video as scenes before and after a point where a visual element is converted, selecting one or more frames representing each scene as representative frames, and extracting image information from the selected representative frames.

2. The system according to claim 1, wherein the first registered-image management module (202) stores an image or a video, which will be a search target, as a registered image or a registered video or searches for and uses the image or the video in real-time through a web.

3. The system according to claim 1, wherein the feature point extracted by the first registered-image information extraction module (203) as image information is information created by a contour, a corner or a polar point (an area brighter or darker than brightness of surrounding areas) included in an image or a video, and the visual attribute of the feature point is brightness information, color information or pattern information that images around the feature point have.

4. The system according to claim 1, wherein the first registered-image information extraction module (203) includes:
a first registered-image image information extraction unit (204) for extracting feature points included in the registered images or visual attributes of the feature points as image information and storing the extracted image information; and
a first registered-video image information extraction unit (205) including:
a first scene partitioning unit (206) for analyzing a registered video and partitioning sections of the video as scenes before and after a point where a visual element is converted;
a first representative frame selection unit (207) for selecting one or more frames representing each scene as representative frames; and
a first representative frame image information extraction unit (208) for extracting feature points or visual attributes of the feature points from the selected representative frames as image information.

5. The system according to claim 4, wherein the first scene partitioning unit (206) creates frequency graphs of HAV (hue/saturation/value) from each frame of video contents, compare graphs of a previous frame and a current frame, and, if a distance between the graphs is larger than a predetermined distance value, determines that the frames are changed and confirm the frames as scenes, and a unique ID is assigned to each of the confirmed scenes.

6. The system according to claim 1, wherein when the feature point or the visual attribute of the feature point, which is image information, is similar to image information in a registered image or a registered video, the class creation module (209) creates or classifies the image information as one or more classes by clustering the image information, and if the classes created at this point have image information similar to that of a previously created class, the class creation module (209) classifies the classes together as identical or similar classes.

7. The system according to claim 1, wherein the class information of the first class information management module (210) includes one or more of image information of each class, category information, text information describing the class and specialized information.

8. The system according to claim 1, wherein the first search contents information extraction module (211) includes:
a first search voice processing unit (214) for analyzing a voice provided by the user terminal and converting the voice into text; and
a first search text processing unit (215) for analyzing a search text provided by the user terminal or the text converted by the first search voice processing unit (214).

9. The system according to claim 1, wherein the first registered-image search module (216) includes:
a first image search unit (217) for searching for identically or similarly matched classes by comparing the image information extracted from a search image or a search video submitted by the user with image information of each class in the class information and searching for registered images or registered videos including some or all of the searched classes; and
a first text search unit (218) for searching for identically or similarly matched classes by comparing text information extracted or converted from a text or a voice submitted by the user with text information in the classes and searching for registered images or registered videos including some or all of the searched classes.

10. An object-based image search system comprising:
an object image management module (301) for registering and storing an object image including one or more objects, extracting image information from the registered object image, and storing the image information together with the object image;
a second class information management module (302) for creating or classifying the image information of the object image extracted through the object image management module (301) as one or more classes according to similarity;
a second registered-image management module 303 for storing and managing various kinds of registered images or videos, which will be a search target;
a second registered-image information extraction module (304) for extracting feature points or visual attributes of the feature points from the registered images or videos as image information;
a registered-image classification module (310) for comparing the image information extracted through the second registered-image information extraction module (304) with image information of the classes and storing information on classes having identical or similar image information together with the registered images or videos;
a second search contents information extraction module (311) for extracting information for searching from an image, a video, a voice or a text received through a user terminal;
a second registered-image search module (316) for searching for identically or similarly matched classes by comparing search contents information extracted through the second search contents information extraction module 311 with image information of the classes and searching for registered images or registered videos including all or some of the searched classes; and
a second search result display module (319) for providing the user terminal with information on the classes or the registered images searched by the second registered-image search module (316) as a search result, wherein
the second search contents information extraction module (311) includes one or more of
a second search image processing unit (312) for extracting image information included in a search image received from a user;
a second search video processing unit (313) for analyzing a search video, partitioning sections of the video as scenes before and after a point where a visual element is converted, selecting one or more frames representing each scene as representative frames, and extracting image information from the selected representative frames;
a second search voice processing unit (314) for analyzing a voice provided by the user terminal and converting the voice into text; and
a second search text processing unit (315) for analyzing a search text provided by the user terminal or the text converted by the second search voice processing unit (314).

11. The system according to claim 10, wherein the image information of the object image is created according to feature point information of a contour, a corner or a polar point (an area brighter or darker than the brightness of surrounding areas) and visual attributes of the feature points, and the image information is created or classified as one or more classes by clustering the image information according to similarity.

12. The system according to claim 10, wherein a unique ID is assigned to each class, and the class information includes one or more of image information of each class, category information, text information describing the class and specialized information describing the class.

13. The system according to claim 10, wherein the second registered-image information extraction module (304) includes:
a second registered-image image information extraction unit (305) for extracting image information from the registered images; and
a second registered-video image information extraction unit (306) for extracting image information from the registered videos.

14. The system according to claim 10, wherein the second registered-image search module (316) includes:
a second image search unit (317) for searching for image information; and
a second text search unit (318) for comparing text.

15. An object-based image search method comprising the steps of:
extracting feature points of a registered image, which will be a search target, or visual attributes of the feature points as image information, through a first registered-image information extraction module (203);
creating or classifying the extracted image information as one or more classes by clustering the image information according to identity or similarity of the image information, by a class creation module (209);
receiving information on the created classes and storing the information as class information, through a first class information management module (210);
if any one of search contents selected from an image, a search video, a voice and a text desired to be searched for is provided by a user terminal, extracting image information of the provided search contents, by a first search contents information extraction module (211);
searching for identical or similar classes by comparing the image information extracted from the search contents with image information of the classes and searching for registered images or registered videos including all or some of the searched classes, by a first registered-image search module (216);
creating information on the searched classes or registered images as a list and providing the user terminal with the list as a search result, through a first search result display module (219); and
if the search contents are a voice, converting the provided voice into text, wherein
classes having an identically or similarly matched text are searched for by comparing the text converted from the voice or a search text directly provided by the user terminal as text with text of the class information.

16. The method according to claim 15, wherein the feature point extracted as image information of the registered image or the search image is information created by a contour, a corner or a polar point (an area brighter or darker than brightness of surrounding areas) included in an image or a video, and the visual attribute of the feature point is brightness information, color information or pattern information that images around the feature point have.

17. The method according to claim 15, wherein the registered video or the search video is analyzed to partition sections of the video as scenes before and after a point where a visual element is converted, select a frame representing each scene as a representative frame, and extract feature points or visual attributes of the feature points from the selected representative frame as image information, and through the process as described above, image information of the feature points or the visual attributes of the feature points is extracted from a registered image or a representative frame.

18. An object-based image search method comprising the steps of:
registering and storing an image including one or more of a variety of objects through an object image management module (301), extracting image information of the registered object image, and creating or classifying the image information as one or more classes by clustering the image information according to identity or similarity of the image information;
receiving and storing the created classes and information on the classes as class information, through a second class information management module (302);
if an image or a video, which will be a search target, is received, extracting image information from a registered image or a registered video, through a second registered-image information extraction module (304);
confirming identically or similarly matched classes by comparing the extracted image information of the registered image or video with image information in the classes, and storing information on the matched classes together in the registered image, through a second registered-image management module (303);
if any one of search contents selected from an image, a search video, a voice and a text desired to be searched for is provided by a user terminal, extracting image information of the provided search contents, by a second search contents information extraction module (311);
searching for matched identical or similar classes by comparing the image information extracted from the search contents with image information of the classes and searching for registered images or registered videos including all or some of the searched classes, by a second registered-image search module (316);
creating information on the searched classes or registered images as a list and providing the user terminal with the list as a search result, through a second search result display module (319); and
if the search contents are a voice, converting the provided voice into text, wherein
classes having an identically or similarly matched text are searched for by comparing the text converted from the voice or a search text directly provided by the user terminal as text with text of the class information.

19. The method according to claim 18, wherein the feature point extracted as image information of the registered image or the search image is information created by a contour, a corner or a polar point (an area brighter or darker than brightness of surrounding areas) included in an image or a video, and the visual attribute of the feature point is brightness information, color information or pattern information that images around the feature point have.

20. The method according to claim 18, wherein the registered video or the search video is analyzed to partition sections of the video as scenes before and after a point where a visual element is converted, select a frame representing each scene as a representative frame, and extract feature points or visual attributes of the feature points from the selected representative frame as image information, and through the process as described above, image information of the feature points or the visual attributes of the feature points is extracted from a registered image or a representative frame.
